(19) United States
(12) Patent Application Publication
(10) Pub. No.: US 2013/0084054 A1
(43) Pub. Date: Apr. 4, 2013

(54) ELECTRONIC APPARATUS AND PLAYBACK CONTROL METHOD

(71) Applicant: Jun Ohashi, Ome-shi (JP)

(72) Inventor: Jun Ohashi, Ome-shi (JP)

(73) Assignee: KABUSHIKI KAISHA TOSHIBA, Tokyo (JP)

(21) Appl. No.: 13/525,810

(22) Filed: Jun. 18, 2012

(30) Foreign Application Priority Data
Sep. 30, 2011 (JP) 2011-217333

(51) Int. Cl. H04N 9/80; H04N 5/93

(52) U.S. Cl. 386/241; 386/E09.011; 386/E05.028

(57) ABSTRACT

According to at least one embodiment, an electronic apparatus determines whether or not a received packet is a first packet in which a random access indicator flag is set. The random access indicator flag indicates that the first packet is a start packet in a packet group required to carry a randomly accessible video frame. If the received packet is the first packet, the apparatus acquires a time stamp indicating a presentation time of the randomly accessible video frame from the first packet or another received packet having the same packet identifier as the first packet, and generates index information indicating the presentation time and a storage position of the first packet in a buffer.

### CROSS-REFERENCE TO RELATED APPLICATIONS

This application is based upon and claims the benefit of priority from prior Japanese Patent Application No. 2011-217333, filed Sep. 30, 2011, the entire contents of which are incorporated herein by reference.

### FIELD

Embodiments described herein relate generally to an electronic apparatus capable of playing back content data, and a playback control method.

### BACKGROUND

In recent years, various electronic apparatuses such as personal computers, PDAs, and smartphones have been developed. Most of such electronic apparatuses have a streaming playback function of playing back multimedia content data while receiving the multimedia content data via the Internet.

In the streaming playback function of multimedia content data, some of multimedia content data received from a content server are stored in a stream buffer in the electronic apparatus.

Player software, which runs on the electronic apparatus, displays a user interface called a seek bar (or progress bar). The user can change (seek) a playback position in multimedia content data by operating the seek bar.

Content data, which has a file format such as MPEG-standardized MP4, includes index information for the seek function.

However, in content data (for example, MPEG-2 TS/TTS content data) of several types, index information for the seek function is not included in the content data. For this reason, the electronic apparatus is required to generate index information corresponding to a stream of MPEG-2 TS/TTS content data by analyzing the picture structure or the like in that stream. However, in general, in order to analyze the picture structure of a stream, processing equivalent to that for decoding the stream is required. For this reason, it is difficult to generate index information in real time while receiving content data.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the outer appearance of an electronic apparatus according to an embodiment;

FIG. 2 is a view showing an example of a content playback screen displayed by player software, which runs on the electronic apparatus according to the embodiment;

FIG. 3 is an exemplary block diagram showing the system arrangement of the electronic apparatus according to the embodiment;

FIG. 4 is an exemplary block diagram showing the configuration of the player software, which runs on the electronic apparatus according to the embodiment;

FIG. 5 is an exemplary view for explaining transport stream (TS) packets received from a server by the player software shown in FIG. 4;

FIG. 6 is an exemplary view for explaining a random access indicator appended to the transport stream (TS) packet shown in FIG. 5;

FIG. 7 is an exemplary view for explaining a packetized elementary stream (PES) packet header assembled by the player software shown in FIG. 4;

FIG. 8 is an exemplary view for explaining a buffer used by the player software shown in FIG. 4;

FIG. 9 is an exemplary view for explaining index information generated by the player software shown in FIG. 4;

FIG. 10 is an exemplary flowchart showing the sequence of a playback control operation executed by the player software shown in FIG. 4;

FIG. 11 is an exemplary flowchart showing the sequence of a buffering operation executed by the player software shown in FIG. 4; and

FIG. 12 is an exemplary flowchart showing the sequence of a seek control operation executed by the player software shown in FIG. 4.

### DETAILED DESCRIPTION

Various embodiments will be described hereinafter with reference to the accompanying drawings.

In general, according to one embodiment, an electronic apparatus plays back content data while receiving packets, which configure a stream of the content data, from a server. This electronic apparatus includes a buffer, playback module, index generation module, and control module. The buffer stores the received packets. The playback module plays back data corresponding to the packets by decoding the packets stored in the buffer. The index generation module determines whether or not the received packet is a first packet in which a random access indicator flag is set, the random access indicator flag indicating that the first packet is a start packet in a packet group required to carry a randomly accessible video frame. If the received packet is the first packet, the index generation module acquires a time stamp indicating a presentation time of the randomly accessible video frame from the first packet or other received packets having the same packet identifier as that of the first packet, and generates index information which indicates the presentation time and a storage position of the first packet in the buffer. The control module determines based on the index information whether or not a first data part corresponding to a change destination playback position requested by the playback module is available on the buffer. Based on the determination result, the control module executes one of processing for transferring the first data part from the buffer to the playback module and processing for receiving the first data part from the server.

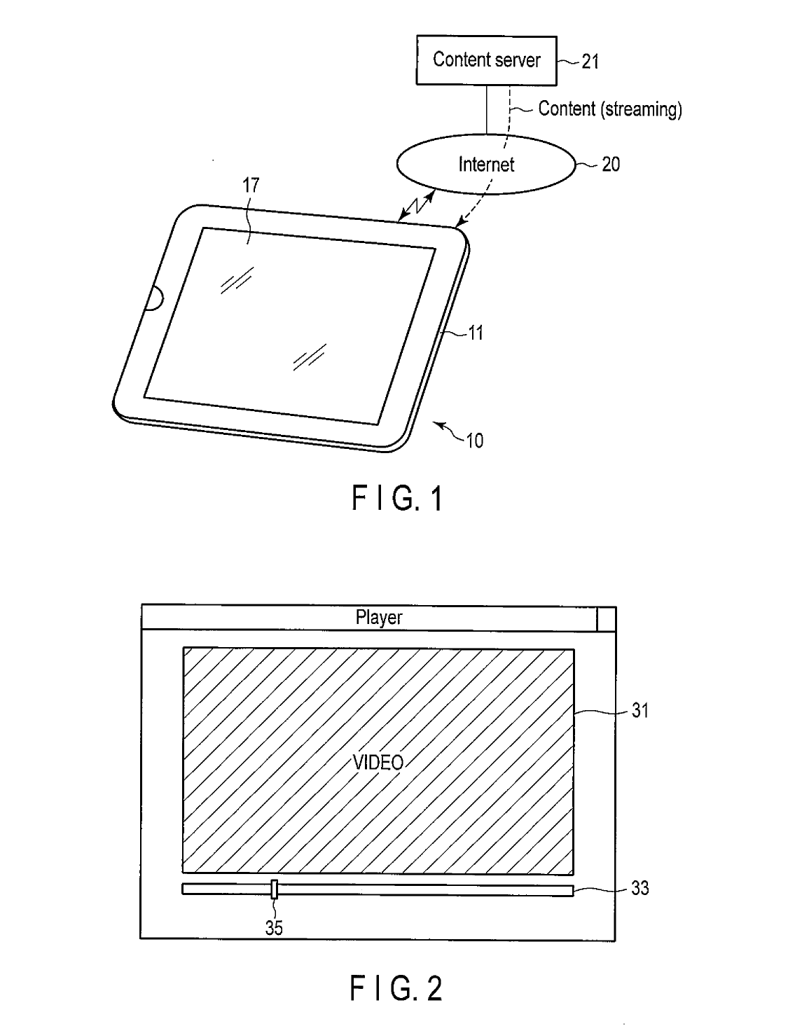

FIG. 1 is a perspective view showing the outer appearance of an electronic apparatus according to one embodiment. This electronic apparatus can be implemented as, for example, a tablet computer, laptop computer, smartphone, PDA, or the like. A case will be assumed below wherein this electronic apparatus is implemented as a tablet computer (slate type computer) 10. The tablet computer 10 is configured by a computer main body 11 and touch screen display 17, as shown in FIG. 1.

The computer main body 11 has a low-profile, box-shaped housing. A liquid crystal display device (LCD) and touch panel are built into the touch screen display 17. The touch panel is arranged to cover the screen of the LCD. The touch screen display 17 is attached to overlap the upper surface of the computer main body 11.

The computer 10 has a content playback function of playing back content data by streaming. This content playback function is executed by player software installed in the computer 10. The content playback function by the player software may be executed using a multimedia framework provided by an operating system in the computer 10. The computer 10 incorporates a communication device used to execute communications with a wired or wireless network, and the communications between the computer 10 and Internet 20 are executed via this communication device.

Content data is a data stream obtained by, for example, multiplexing video data and audio data. The video data may be compression-encoded, and the audio data may also be compression-encoded. The content data may be configured by only video data.

The player software receives content data (multimedia content data) from a content server 21 via a network like the Internet 20. The player software plays back multimedia content data while receiving the multimedia content data. In the computer 10, a received data part in the multimedia content data is stored in a buffer. The buffer is a part of a memory in the computer 10. After data of a given size are stored in the buffer, the player software begins to play back the multimedia content data.

In multimedia content data playback processing, video and audio data parts stored in the buffer are respectively played back. During the multimedia content data playback processing, the player software may execute read-ahead processing. The read-ahead processing is buffering processing which sequentially receives data parts temporally ahead of the current playback position from the content server 21 and stores them in the buffer.

FIG. 2 shows an example of a content playback screen displayed on the display 17 by the player software. The content playback screen has a video display area 31 and seek bar 33. The video display area 31 is that used to display an image (moving image) of video data in the multimedia content data. The seek bar 33 is a graphical user interface required to allow the user to control the playback position of the multimedia content data.

The left end and right end of the seek bar 33 respectively correspond to the start position and end position of multimedia content data to be played back. During a playback period of multimedia content data, the playback position of the multimedia content data is automatically updated along with an elapse of time. As a value indicating the playback position, an offset value, which has the start position of the multimedia content data as an origin, may be used. An offset value corresponding to a certain playback position indicates a playback time period from the start position of the multimedia content data to that playback position.

The seek bar 33 displays a slider 35. The slider 35 indicates the current playback position in the multimedia content data. That is, the slider 35 indicates a playback progress state of the multimedia content data. The user can change the playback position of the multimedia content data by moving the slider 35 using a pointing device.

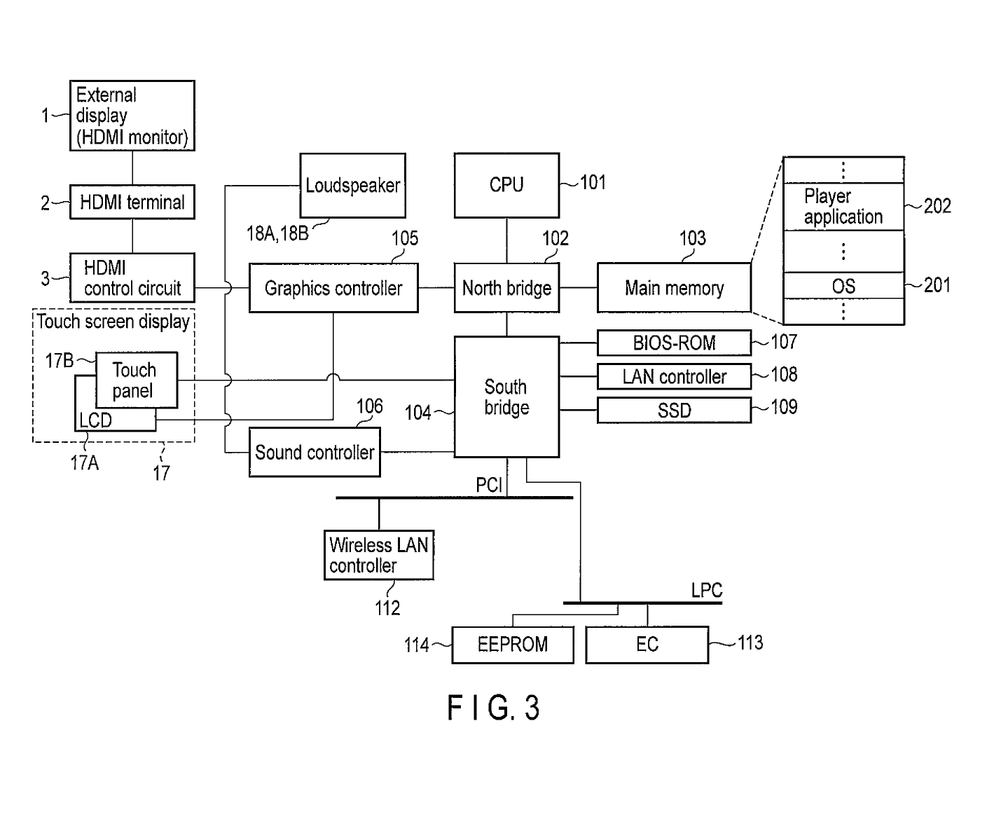

FIG. 3 is a block diagram showing the system arrangement of the computer 10.

As shown in FIG. 3, the computer 10 includes a CPU 101, north bridge 102, main memory 103, south bridge 104, graphics controller 105, sound controller 106, BIOS-ROM 107, LAN controller 108, solid-state drive (SSD) 109, wireless LAN controller 112, embedded controller (EC) 113, EEPROM 114, HDMI control circuit 3, and the like.

The CPU 101 is a processor, which controls the operations of the respective units in the computer 10. The CPU 101 executes an operating system (OS) 201 and various application programs, which are loaded from the SSD 109 onto the main memory 103. The application programs include a player application program 202. This player application program 202 is the aforementioned player software, and runs on the OS 201.

The CPU 101 also executes a BIOS stored in the BIOS-ROM 107. The BIOS is a program for hardware control.

The north bridge 102 is a bridge device which connects between a local bus of the CPU 101 and the south bridge 104. The north bridge 102 also incorporates a memory controller which controls accesses to the main memory 103. The north bridge 102 also has a function of executing communications with the graphics controller 105 via a serial bus of the PCI EXPRESS standard or the like.

The graphics controller 105 is a display controller, which controls an LCD 17A used as a display monitor of the computer 10. A display signal generated by this graphics controller 105 is sent to the LCD 17A. The LCD 17A displays an image based on the display signal. A touch panel 17B is disposed on this LCD 17A. The touch panel 17B is a pointing device used to make inputs on the screen of the LCD 17A. The user can operate a graphical user interface (GUI) and the like displayed on the screen of the LCD 17A using the touch panel 17B. For example, the user can instruct to execute a function corresponding to a given button displayed on the screen by touching that button.

An HDMI terminal 2 is an external display connection terminal. The HDMI terminal 2 can output a non-compressed digital video signal and digital audio signal to an external display device 1 via a single cable. The HDMI control circuit 3 is an interface required to output a digital video signal to the external display device 1 called an HDMI monitor via the HDMI terminal 2. That is, the computer 10 can be connected to the external display device 1 via the HDMI terminal 2 and the like.

The south bridge 104 controls respective devices on a Peripheral Component Interconnect (PCI) bus and those on a Low Pin Count (LPC) bus. The south bridge 104 incorporates an ATA controller required to control the SSD 109.

The south bridge 104 incorporates a USB controller required to control various USB devices. Furthermore, the south bridge 104 also has a function of executing communications with the sound controller 106. The sound controller 106 is a sound source device, which outputs audio data to be played back to loudspeakers 18A and 18B. The LAN controller 108 is a wired communication device, which executes wired communications compliant with, for example, the IEEE 802.3 standard. The wireless LAN controller 112 is a wireless communication device, which executes wireless communications compliant with, for example, the IEEE802.11 standard.

The EC 113 is a single-chip microcomputer which includes an embedded controller for power management. The EC 113 has a function of turning on/off a power supply of the computer 10 in response to an operation of a power button by the user.

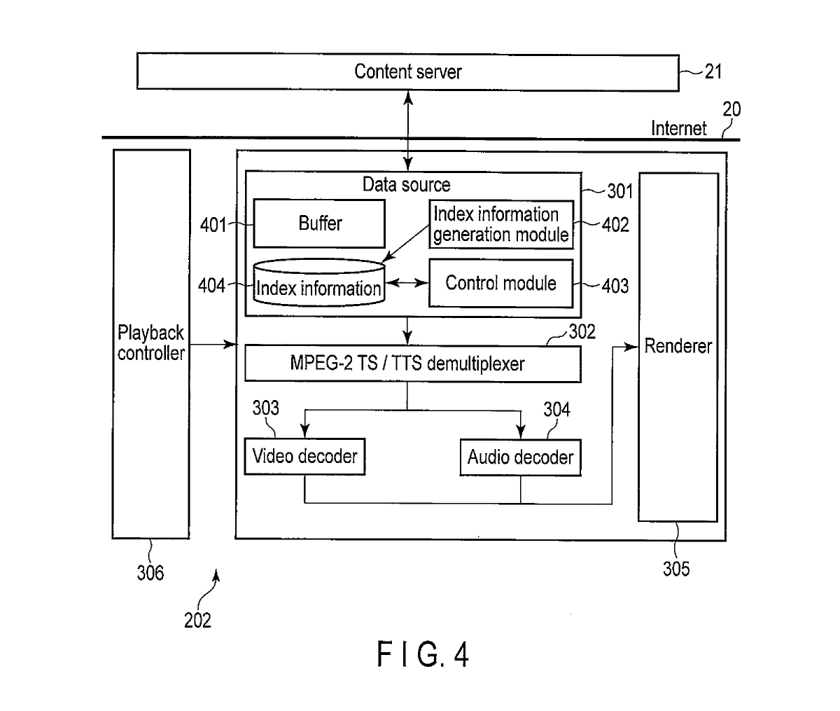

The functional configuration of the player application program 202 will be described below with reference to FIG. 4.

The player application program 202 includes a data source 301, demultiplexer 302, video decoder 303, audio decoder 304, renderer 305, and playback controller 306. The data source 301 sequentially executes processing for receiving multimedia content data from the content server 21, and stores received respective data parts in a buffer 401 (buffering) under the control of the playback controller 306.

In this buffering, the data source 301 sequentially receives packets, which configure a stream of content data, from the server 21. These packets are transport stream (TS) packets. These packets may also be time-stamped TS packets (TTS packets). A TTS packet is one type of TS packets, and is a packet to a head position of which a time stamp is appended. The buffer 401 stores received TS/TTS packets, that is, some data in content data.

The data source 301 further includes an index information generation module 402, control module 403, and index information storage module 404. The index information generation module 402 generates index information required to seek content data in real time during buffering. In order to support the generation operation of the index information, the server 21 is configured to set a random access indicator flag (random_access_indicator) of 1 in a header of a TS packet corresponding to each random access point in content data when it transmits that TS packet corresponding to each random access point.

The TS packet in which the random access indicator flag is set, that is, the TS packet with the random access indicator flag set is a start TS packet in a TS packet group (a plurality of TS packets) required to carry a randomly accessible video frame. One packetized elementary stream (PES) packet required to carry a certain video frame is divisionally transmitted in payloads of TS packets having the same packet identifier (PID). Therefore, the TS packet with the random access indicator flag (random_access_indicator) set is a start TS packet in the plurality of TS packets to which the PES packet required to carry a randomly accessible video frame is distributed. A randomly accessible video frame is, for example, an H.264 instantaneous decoder refresh (IDR) frame, MPEG-2 Video I (Intra) frame, or the like, which can be decoded without referring to other video frames.

The server 21 sets 1 in a random_access_indicator flag included in a header of a start TS packet in a plurality of TS packets to which a PES packet that stores a randomly accessible video frame is assigned.

The index information generation module 402 determines with reference to a header of a received TS packet whether or not the received TS packet is that with the random access indicator flag (random_access_indicator) set, that is, it is a TS packet whose random_access_indicator is set to 1. When the received TS packet is a TS packet (first packet) with the random access indicator flag (random_access_indicator) set, the index information generation module 402 acquires a time stamp indicating a presentation time of a randomly accessible video frame from this TS packet with the random access indicator flag (random_access_indicator) set or another received TS packet having the same packet identifier (PID) as that of the TS packet with the random access indicator flag set.

In this case, the index information generation module 402 may assemble a header of a PES packet used to carry a randomly accessible video frame using the TS packet with the random access indicator flag (random_access_indicator) set and one or more other received TS packets having the same packet identifier as that of the TS packet with the random access indicator flag (random_access_indicator) set, and may acquire a time stamp (presentation time stamp [PTS]) indicating a presentation time of the randomly accessible video frame from the assembled header. The header of the PES packet is distributed to some TS packets in some cases. Therefore, since the header of the PES packet is assembled, and the PTS is acquired from the assembled header, as described above, even when the header of the PES packet is distributed to some TS packets, the PTS corresponding to a randomly accessible video frame can be normally acquired.

Then, the index information generation module 402 generates index information indicating the acquired presentation times (PTS) and a storage position of the TS packet with the random access indicator flag (random_access_indicator) set in the buffer 401. As the storage position of the TS packet with the random access indicator flag (random_access_indicator) set in the buffer 401, for example, an offset position in the buffer 401 where that TS packet is stored is used. This index information is stored in the index information storage module 404. Every time a TS packet (first packet) with a random access indicator flag (random_access_indicator) set is received, index information corresponding to a new randomly accessible video frame is generated. Thus, for each randomly accessible position in data stored in the buffer 401, a pair of the presentation time and the storage position in the buffer 401 is stored in the index information storage module 404 as index information.

The control module 404 determines based on the index information whether or not a first data part corresponding to a change destination playback position requested by the demultiplexer 302 is available on the buffer 401. Based on this determination result, the control module 404 executes one of processing for transferring the first data part from the buffer 401 to the demultiplexer 302 and processing for receiving the first data part from the server 21.

In this way, the index information used in a seek operation is generated by simple processing during buffering, thus improving a seek response.

The demultiplexer 302, video decoder 303, audio decoder 304, and renderer 305 serve as a playback module, which decodes data (TS/TTS packets) stored in the buffer 401 and plays back data (video and audio data) corresponding to these packets.

The demultiplexer 302 receives TS/TTS packets from the buffer 401 in the data source 301, and demultiplexes these TS/TTS packets into those corresponding to video data and those corresponding to audio data, based on PIDs of these TS/TTS packets. The video decoder 303 decodes the TS/TTS packets corresponding to video data, and sends the decoded video data to the renderer 305. The audio decoder 304 decodes the TS/TTS packets corresponding to audio data, and sends the decoded audio data to the renderer 305. The renderer 305 displays a moving image of the video data on the video display area 31. Furthermore, the renderer 305 outputs sound corresponding to the audio data via the loudspeakers and the like.

The playback controller 306 controls the playback operation of content data by the player application program 202. More specifically, the playback controller 306 controls the data source 301, demultiplexer 302, video decoder 303, audio decoder 304, and renderer 305.

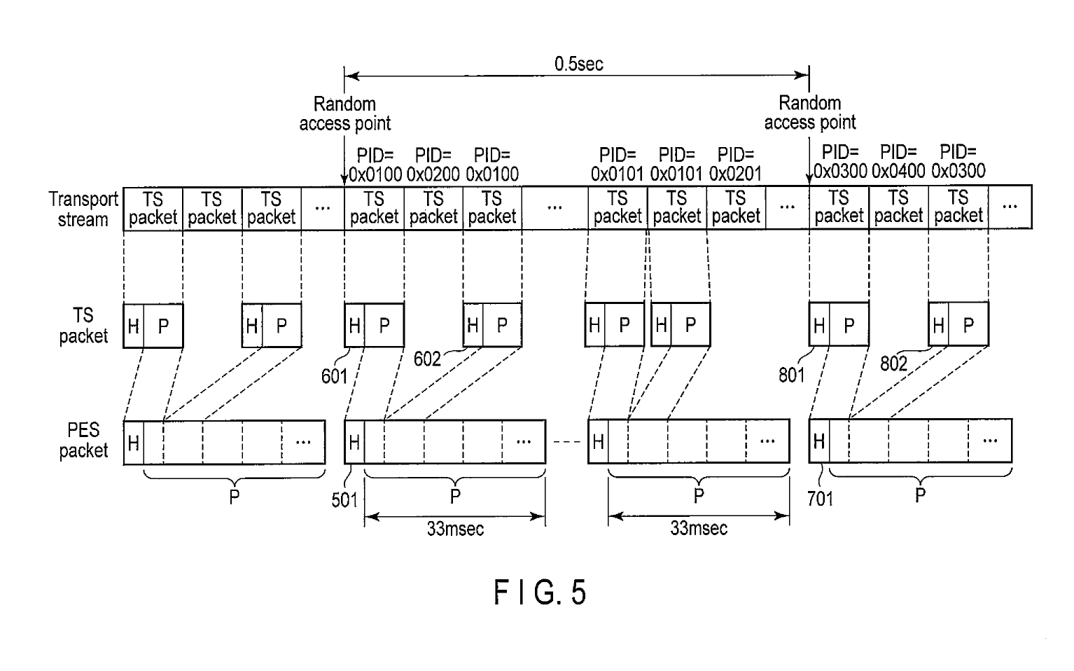

TS packets received from the server 21 by the player software 202 will be described below with reference to FIG. 5.

A transport stream is configured by a string of TS packets (or TTS packets). Each TS packet is a 188-byte long fixed-length packet, and includes a header (H) and payload (P). A bit stream of content data is transmitted by TS packets. In the bit stream, random access points are set. The random access points are set at, for example, intervals of about 0.5 seconds. A position of each randomly accessible video frame in the bitstream corresponds to each random access point. A duration from a certain random access point to the next random access point is, for example, about 0.5 seconds.

The bit stream is packetized by PES packets. A payload (P) of each PES packet includes data of one access unit (one video frame). A header (H) of each PES packet includes a PTS of the corresponding video frame. One PES packet is divisionally transmitted in payloads of a plurality of TS packets having the same PID.

A case will be assumed wherein a payload of a PES packet 501 includes a randomly accessible video frame. The PES packet 501 is divided into a plurality of TS packets 601, 602, . . . having the same PID (0x0100 in this case). In this case, in this embodiment, 1 is set in a flag random_access_indicator included in a header of the start TS packet 601.

Furthermore, a case will be assumed wherein a payload of a PES packet 701 includes a randomly accessible video frame. The PES packet 701 is divided into a plurality of TS packets 801, 802, . . . having the same PID (0x0300 in this case). A 1 is set in a flag random_access_indicator included in a header of the start TS packet 801.

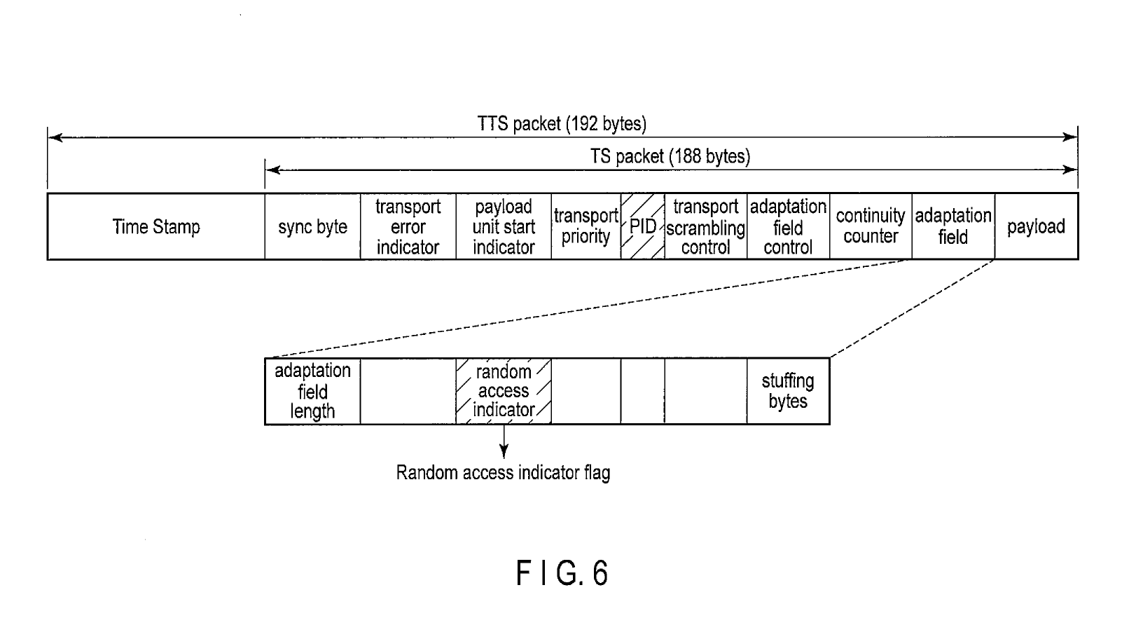

FIG. 6 shows the configuration of a TS/TTS packet. A header of a TS/TTS packet includes a field for storing a PID, that for storing a flag random_access_indicator, and the like. In a normal system, the field for storing the flag random_access_indicator is normally not used. This is because a decoder can determine, for each video frame, whether or not a video frame of interest is a randomly accessible video frame by analyzing a picture structure. However, since a large processing volume is required to analyze the picture structure, if the processing for analyzing the picture structure is executed during buffering processing, a heavy load is imposed on the buffering processing. Hence, the buffering speed may lower, and the content playback performance may be adversely influenced. In this embodiment, a TS packet with the flag random_access_indicator set to 1 is detected, and a PTS included in a header of a PES packet corresponding to this TS packet is acquired. Thus, index information can be generated by simple processing without executing any analysis of the picture structure.

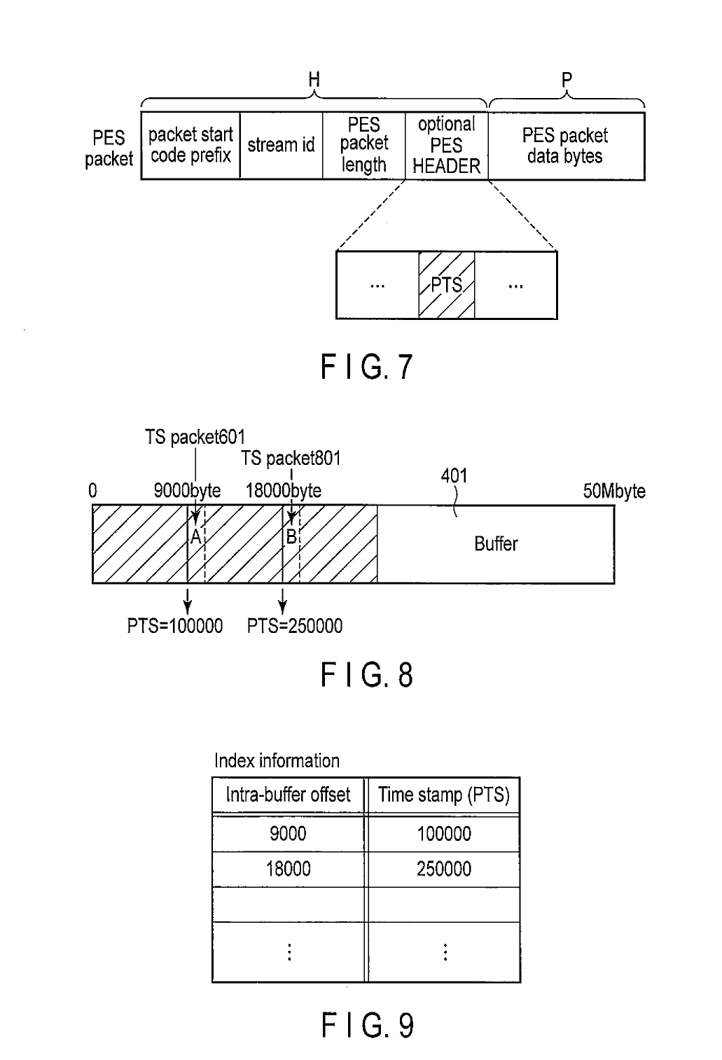

FIG. 7 shows the configuration of a PES packet. A header of a PES packet includes a field for storing a PTS, and the like.

An example of index information will be described below with reference to FIGS. 8 and 9.

A case will be assumed wherein a TS packet 601 with a random access indicator flag (random_access_indicator) set is stored at a storage position A as a 9000th-byte position from the head of the buffer 401, and another TS packet 801 with a random access indicator flag (random_access_indicator) set is stored at a storage position B as a 18000th-byte position from the head of the buffer 401, as shown in FIG. 8.

In this case, a payload of the TS packet 601 or that of a TS packet 602 includes a header of a PES packet 501. Therefore, by referring to the payload of the TS packet 601 or that of the TS packet 602, a PTS (PTS=100000 in this case) of a video frame included in the PES packet 501 can be acquired.

Likewise, a payload of the TS packet 801 or that of a TS packet 802 includes a header of a PES packet 701. Therefore, by referring to the payload of the TS packet 801 or that of the TS packet 802, a PTS (PTS=250000 in this case) of a video frame included in the PES packet 701 can be acquired.

FIG. 9 shows an example of index information. At the time of reception of the TS packet 601, a pair of an intra-buffer offset (=9000) and time stamp (=100000) is generated as index information. Likewise, at the time of reception of the TS packet 801, a pair of an intra-buffer offset (=18000) and time stamp (=250000) is generated as index information.

A pair, which is generated once, is deleted from the index information as needed. This is because processing for assuring a partial or full storage area of the buffer 401 is executed as needed, so as to assure a free area of the buffer 401. For example, when a storage area from a position of the intra-buffer offset (=9000) to a position immediately before the intra-buffer offset (=18000) in the buffer 401 is released and this storage area is set as a free area, the pair of the intra-buffer offset (=9000) and time stamp (=100000) is deleted from the index information.

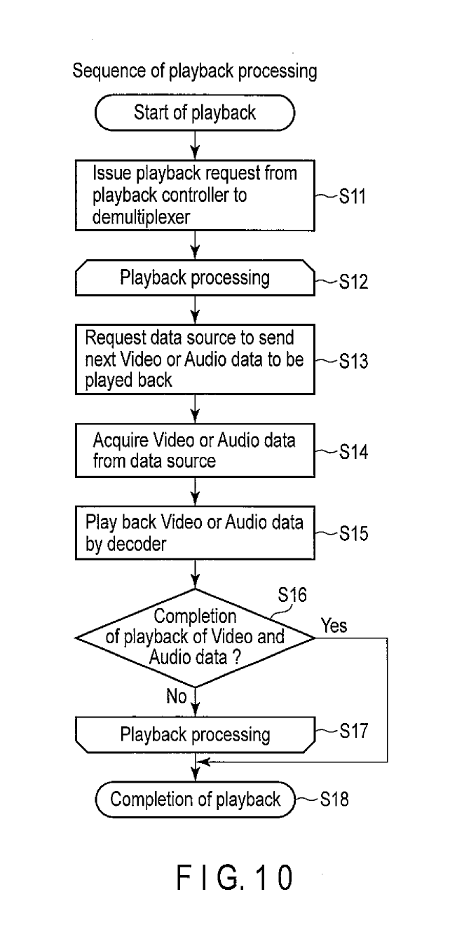

The sequence of playback control processing executed by the player application program 202 will be described below with reference to the flowchart shown in FIG. 10.

In the player application program 202, the data source 301 starts buffering processing for sequentially receiving TS packets of multimedia content data from the content server 21 and storing them in the buffer 401 under the control of the playback controller 306. After data of a given size are stored in the buffer 401, the playback controller 306 issues a playback request to the demultiplexer 302 (step S11), thus starting playback processing (steps S12 to S17) for playing back multimedia content data by streaming.

In the playback processing, the demultiplexer 302 requests the data source 301 to send next data (video or audio data) to be played back (step S13), and acquires the next data (video or audio data) to be played back from the data source 301 (step S14). This data is played back after it is decoded by the video decoder 303 or audio decoder 304 (step S15). In this case, TS packets corresponding to video data are sent from the demultiplexer 302 to the video decoder 303, and those corresponding to audio data are sent from the demultiplexer 302 to the audio decoder 304.

Furthermore, in the playback processing, the playback controller 306 determines whether or not a playback operation of the multimedia content data is complete, that is, whether or not the playback operation has progressed, and the playback position has reached the end of the multimedia content data (step S16). Until the playback operation of the multimedia content data is complete, a loop of the playback processing from step S12 to step S17 is repetitively executed. After the playback operation has progressed, and the playback position has reached the end of the multimedia content data (YES in step S16), the playback processing is complete (step S18).

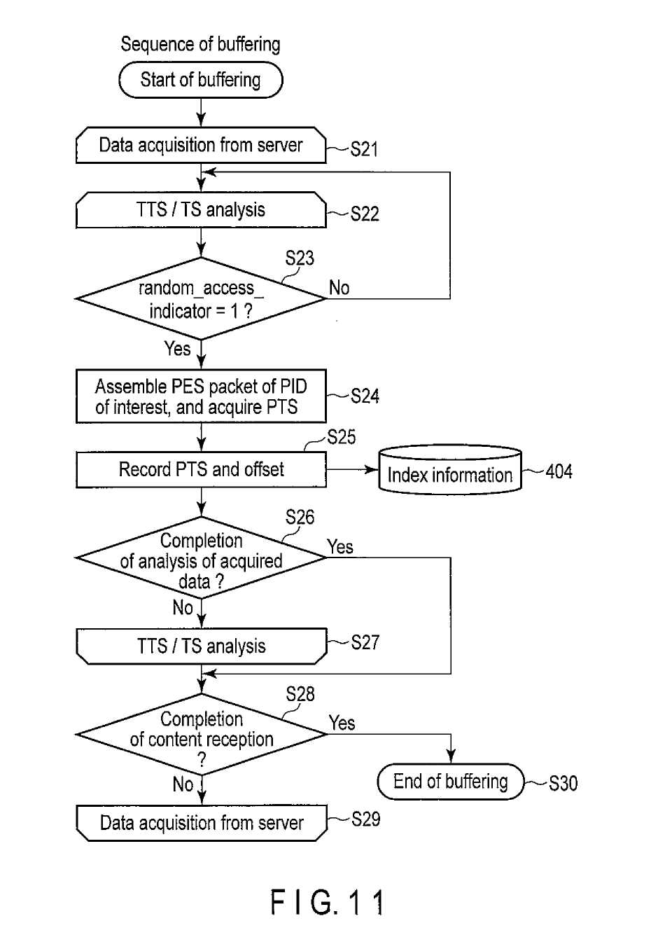

The buffering processing executed by the player application program 202 will be described below with reference to the flowchart shown in FIG. 11.

The buffering processing includes a loop (steps S21 to S29) of reception processing for sequentially receiving data from the server 21. This reception processing loop (steps S21 to S29) includes a loop (steps S22 to S27) of analysis processing for generating the aforementioned index information by analyzing a TTS/TS packet received from the server 21.

The data source 301 receives TTS/TS packets which configure a stream of content data from the server 21 (step S21). The received TTS/TS packets are stored in the buffer 401. Every time one TTS/TS packet is received, the index information generation module 402 of the data source 301 executes the following processing.

The index information generation module 402 determines whether or not the received TTS/TS packet is that with a random access indicator flag (random_access_indicator) set (step S23). In step S23, the index information generation module 402 determines whether or not the random access indicator flag (random_access_indicator) included in a header of the received TTS/TS packet is 1.

If the received TTS/TS packet is that with the random access indicator flag (random_access_indicator) set, that is, if it is a first TTS/TS packet in a TTS/TS packet group required to carry a randomly accessible video frame (YES in step S23), the index information generation module 402 executes processing for acquiring a time stamp (PTS) included in a header of a PES packet corresponding to the received TTS/TS packet (step S24).

In step S24, the index information generation module 402 acquires a time stamp (PTS) indicating a presentation time of a randomly accessible video frame from a payload of the received TTS/TS packet or from that of another received TTS/TS packet having the same PID as that of the received TTS/TS packet.

Alternatively, the index information generation module 402 may assemble a PES packet using the received TTS/TS packet and all other received TTS/TS packets having the same PID as that of the received TTS/TS packet, and may acquire a time stamp (PTS) from a header of this PES packet. Of course, a full PES packet need not be assembled. The data source 301 may assemble a header of a PES packet using the received TTS/TS packet and one or more other received TTS/TS packets having the same PID as that of the received TTS/TS packet.

The index information generation module 402 generates a pair of an offset of a storage position of the TTS/TS packet with the random access indicator flag (random_access_indicator) set in the buffer 401, and the aforementioned PTS as index information, and stores this index information in the index information storage module 404 (step S25).

The index information generation module 402 determines whether or not the analysis processing for all TTS/TS packets acquired from the server 21 is complete (step S26). Until the analysis processing for all the acquired TTS/TS packets is complete, the analysis processing in steps S22 to S27 is repetitively executed.

After completion of the analysis processing for all the acquired TTS/TS packets (YES in step S26), the data source 301 determines whether or not the reception processing of the content data is complete (step S28). Until the reception processing of the content data is complete, the reception processing in steps S21 to S29 is repetitively executed. After completion of the reception processing of the content data (YES in step S28), the buffering processing ends (step S30).

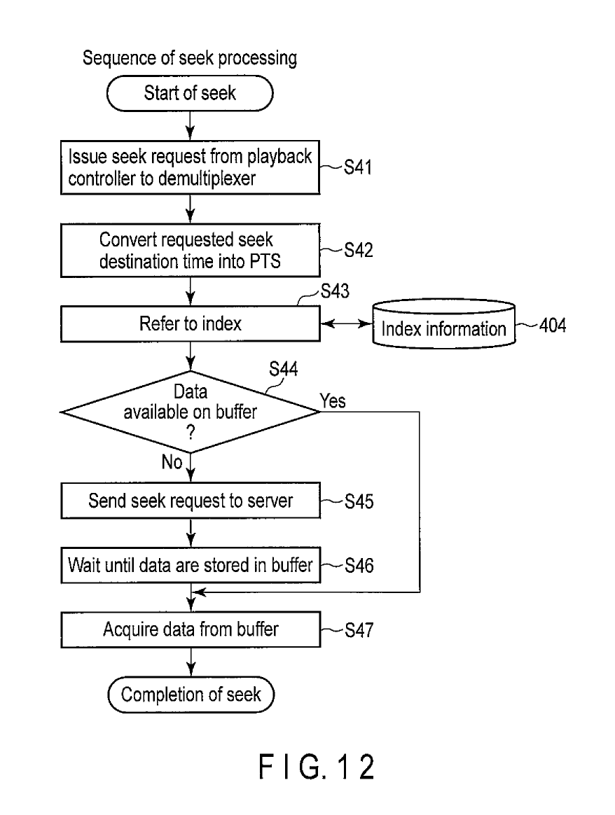

Playback position change (seek) processing will be described below with reference to the flowchart shown in FIG. 12.

For example, when a playback position is changed to a position (change destination playback position) different from the current playback position by a moving operation of the slider 35 by the user, the following seek control operation is executed.

That is, the playback controller 306 requests the demultiplexer 302 to change the playback position to the change destination playback position (step S41). The demultiplexer 302 requests the data source 301 to send a data part corresponding to the change destination playback position under the control of the playback controller 306. The change destination playback position indicates a presentation time (seek destination time) corresponding to the change destination playback position. This seek destination time indicates a playback time period from the start position of content data to that change destination playback position. The precision of the seek destination time can be that which allows to designate a playback position in, for example, a msec unit. On the other hand, the precision of a presentation time indicated by a PTS is 1/90 kHz, and is higher than that of the seek destination time. For this reason, the control module 403 of the data source 301 executes processing for converting the seek destination time into the precision of a PTS (scaling processing) (step S42). Since a PTS corresponding to a start position of content data is not always zero, an offset value of the PTS corresponding to the start position is calculated, and this offset value is subtracted from a PTS obtained by converting the seek destination time in step S42. As the offset value, a value of a PTS set in a first PES packet of content data may used, or a value of a PTS in a first PES packet of video or audio data may be used (step S42).

The control module 403 of the data source 301 determines with reference to index information whether or not a data part corresponding to the converted seek destination time (a first data part corresponding to the change destination playback position) is available on the buffer 401 (steps S43 and S44). For example, if the converted seek destination time belongs to a range from a minimum PTS to a maximum PTS registered in the index information, it is determined that the data part corresponding to the converted seek destination time (the first data part corresponding to the change destination playback position) is available on the buffer 401.

Based on this determination result, the control module 403 executes one of processing for transferring the first data part corresponding to the change destination playback position from the buffer 401 to the demultiplexer 302 on the basis of the index information, and processing for receiving the first data part from the server 21.

More specifically, if the data part corresponding to the converted seek destination time (the first data part corresponding to the change destination playback position) is available on the buffer 401, the control module 403 acquires the first data part corresponding to the change destination playback position from the buffer 401, and sends the acquired first data part to the demultiplexer 302 (step S47). In the aforementioned example of FIGS. 8 and 9, for example, if the converted seek destination time belongs to a range from PTS=100000 to PTS=250000, it is determined that the first data part corresponding to the change destination playback position (a randomly accessible video frame corresponding to the change destination playback position) is available on the buffer 401. If the converted seek destination time is larger than PTS=100000 and is less than PTS=250000, for example, a random access point (PTS=250000) immediately after the converted seek destination time is decided as a seek destination position. In other words, a data part stored at a storage position corresponding to an offset value=18000 bytes is decided as the first data part corresponding to the change destination playback position. Then, that data part is read from the buffer 401, and is transferred to the demultiplexer 302.

On the other hand, if the data part corresponding to the converted seek destination time (the first data part corresponding to the change destination playback position) is not available on the buffer 401, the control module 403 of the data source 301 requests the server 21 to send the first data part and data parts which follow the first data part (step S45), and receives the first data part and the data parts which follow the first data part from the server 21. The control module 403 of the data source 301 waits until data of a predetermined data size are stored in the buffer 401 (step S46). During this waiting time period, the playback operation of the content data is paused. Also, during this data reception processing, the data source 301 executes the aforementioned index generation processing.

After the data of the predetermined data size are stored in the buffer 401, the data source 301 acquires the first data part corresponding to the change destination playback position from the buffer 401, and sends the acquired first data part to the demultiplexer 302 (step S47).

As described above, according to this embodiment, it is determined whether or not a received packet is a first packet in which a random access indicator flag is set. The random access indicator flag indicates that the first packet is a start packet in a packet group required to carry a randomly accessible video frame. If the received packet is the first packet in which the random access indicator flag is set, a time stamp (PTS) indicating a presentation time of the randomly accessible video frame is acquired from the first packet or another received packet having the same packet identifier as that of the first packet. Then, index information indicating the acquired presentation time and a storage position of the first packet in the buffer 401 is generated. Whether or not a data part corresponding to the change destination playback position is available on the buffer 401 can be determined based on this index information.

Hence, even when content data which does not include any index information is played back by streaming, index information corresponding to the content data can be generated while receiving the content data. Therefore, seek processing required to change the current playback position of the content data to another playback position can be executed based on this index information. Thus, the response of the seek processing can be improved.

Note that all the processing sequences of this embodiment, which have been described using the flowcharts shown in FIGS. 10, 11, and 12 can be implemented by software. For this reason, by only installing and executing computer program required to implement these processing sequences in a normal computer via a computer-readable storage medium which stores the computer program thereon, the same effects as in this embodiment can be easily attained.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions.

Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus configured to play back content data while receiving packets of a stream of the content data from a server, the apparatus comprising:
a buffer configured to store the received packets;
a playback module configured to play back data corresponding to the packets by decoding the packets stored in the buffer;
an index generator
configured to determine that a received packet is a first packet in which a random access indicator flag is set, the random access indicator flag indicating that the first packet is a start packet in a packet group for carrying a randomly accessible video frame,
configured to acquire a time stamp indicating a presentation time of the randomly accessible video frame from the first packet or another received packet having the same packet identifier as the first packet when the received packet is the first packet, and
configured to generate index information indicating the presentation time and a storage position of the first packet in the buffer; and
a controller configured to determine, based on the index information, that a first data part corresponding to a change destination playback position requested by the playback module is available on the buffer, and configured to execute, based on the determination, processing for transferring the first data part from the buffer to the playback module or processing for receiving the first data part from the server.

2. The apparatus of claim 1,
wherein the index generator is
configured to assemble a header of a packetized elementary stream (PES) packet for carrying the randomly accessible video frame using the first packet and one or more other received packets having the same packet identifier as the first packet, and
configured to acquire the time stamp indicating the presentation time of the randomly accessible video frame from the assembled header.

3. The apparatus of claim 1,
wherein the packets are transport stream (TS) packets.

4. The apparatus of claim 1,
wherein the server is configured to set the random access indicator flag in a start packet of packets for carrying a randomly accessible video frame.

5. A playback control method of playing back content data while receiving packets of a stream of the content data from a server, the method comprising:
storing the received packets in a buffer;
playing back data corresponding to the packets by decoding the packets stored in the buffer;
determining that a received packet is a first packet in which a random access indicator flag is set, the random access indicator flag indicating that the first packet is a start packet in packets for carrying a randomly accessible video frame;
acquiring a time stamp indicating a presentation time of the randomly accessible video frame from the first packet or another received packet having the same packet identifier as the first packet, when the received packet is the first packet;
generating index information indicating the presentation time and a storage position of the first packet in the buffer;
determining, based on the index information, that a first data part corresponding to a change destination playback position requested by a playback position change request is available on the buffer; and
executing, based on the determination result, processing for transferring the first data part from the buffer to a playback module or processing for receiving the first data part from the server.

6. The method of claim 5,
wherein generating the index information comprises
assembling a header of a packetized elementary stream (PES) packet for carrying the randomly accessible video frame using the first packet and one or more other received packets having the same packet identifier as the first packet; and
acquiring the time stamp indicating the presentation time of the randomly accessible video frame from the assembled header.

7. A computer-readable, non-transitory storage medium having stored thereon a computer program, which controls a computer to play back content data while receiving packets of a stream of the content data from a server, the computer program controlling the computer to execute functions of:
storing the received packets in a buffer;
playing back data corresponding to the packets by decoding the packets stored in the buffer;
determining that a received packet is a first packet in which a random access indicator flag is set, the random access indicator flag indicating that the first packet is a start packet in packets for carrying a randomly accessible video frame;
acquiring a time stamp indicating a presentation time of the randomly accessible video frame from the first packet or another received packet having the same packet identifier as the first packet, when the received packet is the first packet;
generating index information indicating the presentation time and a storage position of the first packet in the buffer;
determining, based on the index information, that a first data part corresponding to a change destination playback position requested by a playback position change request is available on the buffer; and
executing, based on the determination result, processing for transferring the first data part from the buffer to a playback module or processing for receiving the first data part from the server.
